(19) United States
(12) Patent Application Publication
(10) Pub. No.: US 2026/0102237 A1
(43) Pub. Date: Apr. 16, 2026

(54) Electric toothbrush with toothpaste dispensing function, stand, case and transferable ultraviolet sterilizer

(71) Applicants: Kirill Borisovich Nesterov, Franconville (FR); Oleg Bogumirskiy, Warsaw (PL); Vladimir Gorovoy, Helsinki (FI); Daniel Jamie, Oak Park, MI (US)

(72) Inventors: Kirill Borisovich Nesterov, Franconville (FR); Oleg Bogumirskiy, Warsaw (PL); Vladimir Gorovoy, Helsinki (FI); Daniel Jamie, Oak Park, MI (US)

(21) Appl. No.: 19/415,117

(22) Filed: Dec. 10, 2025

Related U.S. Application Data
(63) Continuation of application No. PCT/RU2023/000218, filed on Jul. 18, 2023.

(51) Int. Cl. A61C 17/22; A61C 17/34

(52) U.S. Cl. CPC A61C 17/227; A61C 17/224; A61C 17/3481

(57) ABSTRACT

Electric toothbrush includes a head mounted on a handle with bristles; handle divided into first and second compartments; first compartment includes toothpaste reservoir and piston for pushing out the toothpaste; second compartment including control unit and motor that generates vibration transmitted to the bristles; head includes toothpaste dispenser with channel for dispensing the toothpaste from the reservoir; dispenser includes first and second valves, first valve is mounted at entry to channel, and second valve is mounted next to the bristles; first valve dispenses toothpaste from the reservoir into channel; second valve dispenses the toothpaste from air volume in the head to the bristles; a push-button on the head for operating the valves; and piston in first compartment, for pumping toothpaste out of reservoir; handle includes a neck with an opening for mating with head and for filling reservoir with toothpaste; handle includes button for activating motor.

### BACKGROUND OF THE INVENTION

### Field of the Invention

The group of inventions relates to devices for cleaning teeth, specifically to an electric toothbrush with a toothpaste dispensing function, and to toothbrush accessories: a stand, a case and a sterilizer.

### Background of the Related Art

The toothbrush is the main tool for mechanical removal of dental plaque. To date, there is a wide range of toothbrushes: mechanical, electric, sonic and ultrasonic toothbrushes.

The claimed group of inventions relates to an electric toothbrush with replaceable heads, which toothbrush is mounted in a stand with a UV sterilizer.

The prior art provides electric toothbrushes, in particular RU516087 provides an oral care kit, comprising: a toothbrush comprising a head, a handle, a relatively narrow constricted section connecting the head and the handle, a dispensing device disposed in the constricted section for dispensing an active substance to at least one outlet opening, and an actuating device for actuating the dispensing device; and one or more reservoirs each comprising one or more active substances.

US 2005238412 A1, Oct. 27, 2005, provides an automatic toothbrush with a toothpaste dispenser, which toothbrush comprises a head mounted on top of the body. A toothpaste reservoir is disposed in the body together with a pump assembly and a first motor. The first motor is coupled to the battery and actuates the pump assembly when the first switch is pressed, causing toothpaste to be forced from the reservoir through a channel onto the bristles of the toothbrush head. The toothbrush head comprises a rotor with rotor bristles, said rotor is operably coupled to a second motor. The second motor may be energized when the second switch is triggered to cause the rotor to move. The invention may include a charging dock for recharging a rechargeable battery of the toothbrush.

The prior art automatic toothbrushes have disadvantages, in particular the accumulation of bacteria on the surface of the bristles as a result of repeated use of the toothbrush. After some time, bacteria accumulate and can “migrate” back to the surface being cleaned, creating the risk of developing multiple negative consequences.

### SUMMARY OF THE INVENTION

The technical result of the claimed group of inventions is that of sanitation of the toothbrush using a UV sterilizer which is a universal UV sterilizer and can be mounted both in the toothbrush stand and in the toothbrush case.

The technical result is achieved by implementing the electric toothbrush with a toothpaste dispensing function, said electric toothbrush comprising a head and a handle, the body of the handle is divided into two compartments, one for housing a toothpaste reservoir and a toothpaste dispensing mechanism, and the other compartment is configured sealed for housing a control unit and a miniature vibration motor which generates vibrations transmitted to the bristles via the head, wherein the head accommodates a toothpaste dispensing mechanism comprising an outlet channel for dispensing toothpaste from the toothpaste reservoir and V-port check valves, wherein two V-port check valves are mounted on each side of the channel, one is configured to dispense toothpaste from the channel to the bristles of the head, the other is configured to dispense toothpaste from the air compartment and/or toothpaste compartment to the outlet channel for dispensing toothpaste, and the third V-port check valve is configured to dispense toothpaste from the toothpaste reservoir to the air compartment and/or toothpaste compartment; wherein, for dispensing toothpaste, a button—a push-button dispenser is disposed on the head, the compartment with the toothpaste reservoir is provided with a toothpaste dispensing mechanism configured in the form of a free-stroke piston with a toothpaste filling sensor, for pumping or bleeding air during the movement of the piston in the bottom of the compartment with the toothpaste reservoir and with the toothpaste dispensing mechanism there is provided an opening which is dockable to an opening in the lid mounted in the bottom of the body of the handle, wherein the body of the handle comprises a neck for filling with toothpaste from a tube, on the outer portion of the body of the handle there are mounted: a button for activating the miniature vibration motor, a USB-C socket for charging the battery, a light indicator for filling with toothpaste, and a magnet for mounting the electric toothbrush upright in the stand.

The electric toothbrush with a toothpaste dispensing function is mounted in the stand by way of a bottom-up movement and is held in the stand by means of magnets mounted on the body of the handle of the electric toothbrush and on the body of the stand.

The stand for an electric toothbrush comprises a holding member with magnets for the toothbrush and a base, wherein in the upper portion of the holding member there is mounted a UV sterilizer assembly configured to house an electric toothbrush head and a UV sterilizer which is mounted and held in the assembly by means of magnets.

The case for an electric toothbrush is intended to store and sanitize the toothbrush, said case comprising a body with a door, wherein the upper portion of the body is provided with an assembly for mounting a UV sterilizer which is connected by means of the attraction of magnets in the bottom of the UV sterilizer and the counter magnets in the case.

The UV sterilizer configured to be mounted in the stand and the case for an electric toothbrush by means of magnets in the bottom of the body thereof comprises a built-in motion sensor with UV lamps.

### BRIEF DESCRIPTION OF THE ATTACHED FIGURES

The accompanying drawings, which are included to provide a further understanding of the invention and are incorporated in and constitute a part of this specification, illustrate embodiments of the invention and, together with the description, serve to explain the principles of the invention.

In the drawings:

FIG. 1 is an electric toothbrush with a toothpaste dispensing function.

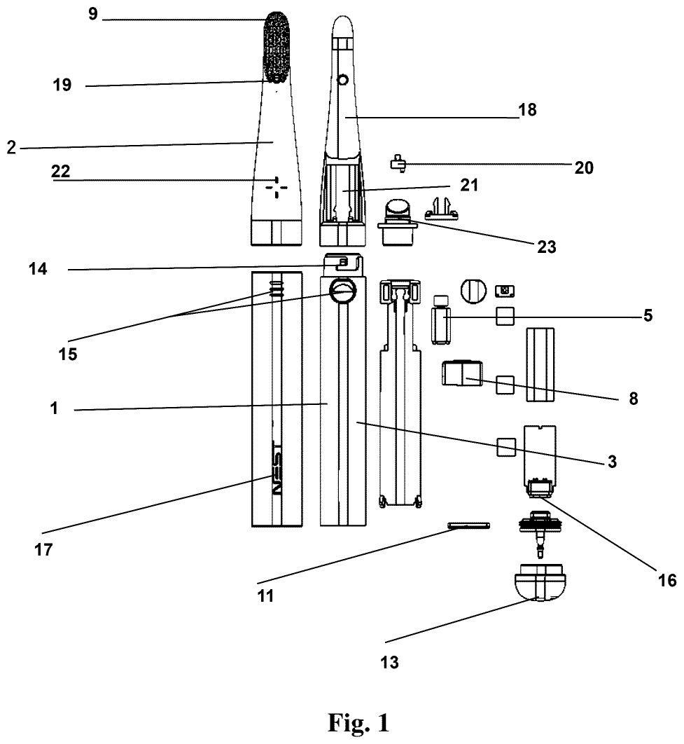

FIG. 2 is a stand with a toothbrush and a UV sterilizer which are mounted thereon.

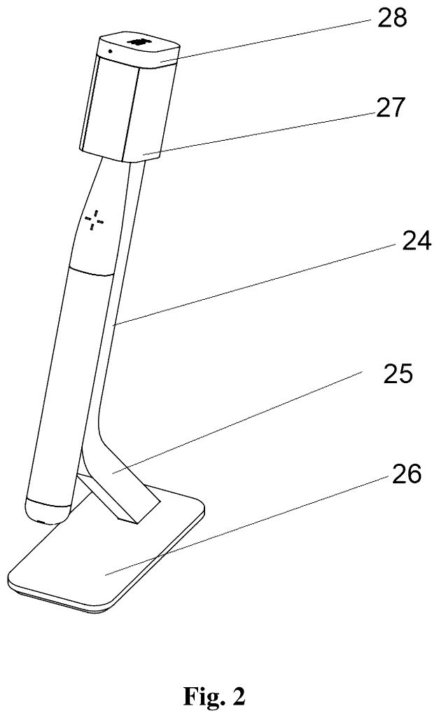

FIG. 3 is a case for an electric toothbrush with a toothpaste dispensing function.

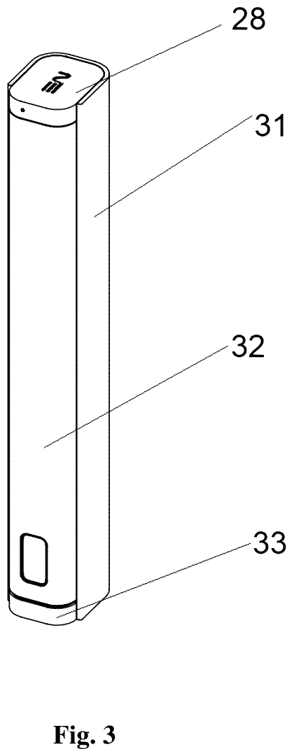

FIG. 4 is a UV sterilizer.

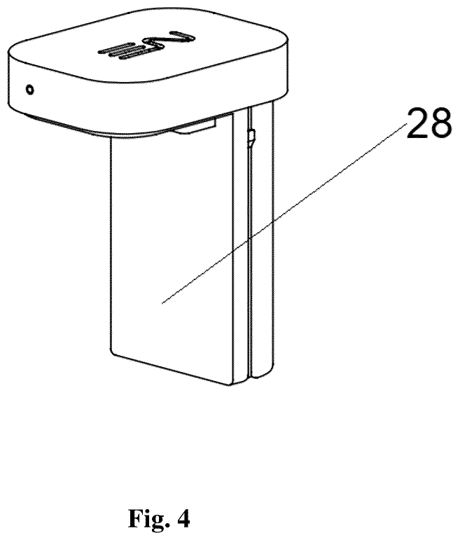

### DETAILED DESCRIPTION OF EMBODIMENTS OF THE INVENTION

Reference will now be made in detail to the preferred embodiments of the present invention, examples of which are illustrated in the accompanying drawings.

The electric toothbrush with a toothpaste dispensing function comprises a handle 1 and replaceable heads 2. The handle of the toothbrush is interiorly divided lengthwise into two compartments: one compartment 3 with a control unit 4 and a miniature vibration motor 5; the second compartment 6 for a toothpaste reservoir 7, interiorly there is provided a toothpaste dispensing mechanism configured in the form of a free-stroke piston 8.

The miniature vibration motor 5 generates vibrations that are transmitted to bristles 9 via the head 2.

Mounted into the compartment 6 with the toothpaste reservoir 7 is a toothpaste dispensing mechanism configured in the form of a free-stroke piston 8 with a toothpaste filling sensor 10. In order to pump or bleed air during the movement of the piston, provided in the bottom of the compartment 6 is an opening 11 which is dockable to an opening 12 (not shown in the drawing) in the lid 13 mounted in the bottom of the body of the handle 1.

The body of the handle 1 comprises a neck 14 for docking to a toothpaste tube when filling the reservoir 7 with toothpaste from the tube.

Provided on the external portion of the body of the handle 1 are a button for activating the miniature vibration motor 15, a USB-C socket 16 for charging the battery, an indicator for filling toothpaste 17 and a magnet for mounting the electric toothbrush upright in the stand.

The head 2 comprises a toothpaste dispensing mechanism comprising an outlet channel 18 for dispensing toothpaste from the toothpaste reservoir 7. Provided on each side of the outlet channel 17 are V-port check valves 19 and 20, one valve (19) is intended for dispensing toothpaste from the channel to the bristles of the head, and the other valve (20) is intended for dispensing toothpaste from the compartment 21 for air and/or toothpaste into the outlet channel 18 for dispensing toothpaste. In order to dispense toothpaste, disposed on the head is a button-a push-button dispenser 22. Mounted in the bottom of the head is a V-port valve 23 for dispensing toothpaste from the reservoir 7 into the compartment 21.

Before using the electric toothbrush, it is necessary to fill the toothpaste reservoir 7; to this end, the head 2 is removed and the neck of the toothpaste tube is inserted into the opening of the neck 14 in the handle. Toothpaste is squeezed out of the tube into the toothpaste reservoir 7 disposed in the compartment 6 of the handle 1. The free-stroke piston 8 is present in the upper position. When compartment 6 is filled with toothpaste, said free-stroke piston moves downwards, the air from the reservoir escapes through the opening 11 in the bottom of the compartment 6 and through the opening 12 in the lid which is mounted in the bottom of the handle 1. On the front side in the bottom of the handle 1 there is present a light indicator 17 with a motion sensor. The free-stroke piston 8 is provided with a response sensor 10. As soon as the free-stroke piston 8 moves down, the light indicator 17 with the motion sensor is triggered in order to indicate that the toothbrush is completely filled with toothpaste. The tube is removed. The head 2 is fitted. The button—the push-button dispenser 22 is pressed, the air escapes from the opening in the upper portion of the head. The button 22 is released, the toothpaste is sucked out of the reservoir into the outlet channel 18 of the head 2 under the action of negative pressure. With the next press, the toothpaste is pumped from the outlet channel 18 in the head to dispense the toothpaste onto the bristles 9.

In order to dispense toothpaste from the compartment 21 to the bristles 9 of the head 2 of an electric toothbrush, the button—the push-button dispenser 22 is used. When pressing the button—the push-button dispenser 22, the inner portion of the button—the push-button dispenser 22 creates pressure on the toothpaste compartment 21. At this point, the V-port/check valve 23 neutralizes the pressure to the toothpaste reservoir 7, thereby preventing toothpaste from being squeezed out of the compartment 21 into the toothpaste reservoir 7. The toothpaste, due to the pressure created in the compartment 21, is squeezed out through the v-port/check valve 20 into the toothpaste outlet channel 18, and on through the v-port/check valve 19 onto the bristles 9. After the pressure on the button—the push-button dispenser 22 is stopped, the button returns to the original position thereof in the process of pressure equalization as a result of the generated vacuum which is generated by filling the compartment 21 with toothpaste coming from the toothpaste reservoir 7 by means of the opening of the valve 20 and the upward movement of the free-stroke piston 8 due to the natural suction of the air from the opening 11, thereby creating the effect of pressure compensation in the compartment 21 and the toothpaste reservoir 7. Simultaneously therewith, under the action of negative pressure, the valve 20 and valve 19 close, preventing the reverse suction of toothpaste into the outlet channel 18.

Activating the miniature electric motor: the button 15 on the handle 1 is pressed, then the miniature vibration motor 5 is switched on, the motor creates micro-vibrations transmitted through a rigid connection and through the head 2 to the bristles 9. To refill the electric toothbrush with toothpaste, one needs to repeat the steps. The built-in battery of the electric toothbrush is charged via the USB-C socket 16 in the bottom of the electric toothbrush.

The claimed electric toothbrush with a toothpaste dispensing function allows the use of any toothpaste of any viscosity from any standard tube, in particular the handle 1 is a reusable reservoir for toothpaste, it can be filled with toothpaste an infinite number of times and, if necessary, rinsed between refills to clean off traces of toothpaste.

The electric toothbrush stand 24 comprises a holding member 25 with magnets for a toothbrush and a base 26, in the upper portion of the holding member there being provided an assembly 27 for a UV sterilizer configured to house a head 2 of an electric toothbrush and a UV sterilizer 28 which is mounted and held in the assembly using magnets.

The stand 24 can be mounted on any flat surface. A protective film is preliminarily peeled off the reusable adhesive base 26. The stand 24 is pressed with fingers to the surface to stick to same. The stand 24 can then be unstuck and sticked back on without damaging the surface an unlimited number of times due to the properties of the adhesive base.

The electric toothbrush with a toothpaste dispensing function is mounted in the stand 24 with a sliding bottom-up movement and is readily magnetized to the stand so that the toothbrush head 2 gets into the assembly 27 for the UV sterilizer 28. Immediately after installing the electric toothbrush into the assembly 27 for the UV sterilizer and the UV sterilizer 28, the motion sensor 29 in the UV sterilizer 28 is triggered, activating the UV lamps 30. The electric toothbrush is cleaned by UV light. The UV lamps 30 are programmed for a specific operating time, after which they automatically switch off. They are switched on again every time the electric toothbrush is mounted in the assembly 27 with the UV sterilizer 28 and are switched off after a programmed time, or if the toothbrush is removed from the stand 24.

The case 31 is configured to store and sanitize the electric toothbrush. The UV sterilizer 28 is mounted into the case. It is connected by means of attraction of magnets in the bottom of the UV sterilizer 28 and the counter magnets in the case. To install the electric toothbrush into the case 31, the bottom of the door 32 is pressed and the electric toothbrush is placed into the interior of the body 33 of the case. The door 32 is closed, the motion sensor 29 in the UV sterilizer 28 is triggered, activating the UV lamps 30. The electric toothbrush is cleaned by UV light. The UV lamps 30 are programmed for a specific operating time, after which they automatically switch off. They are switched on again every time the electric toothbrush is mounted into the assembly 27 for the UV sterilizer 28 and are switched off after a programmed time, or if the door 32 is opened.

The UV sterilizer 28 has a built-in motion sensor 29 with UV lamps 30. Thus, it is activated only when the electric toothbrush approaches same at a certain distance. The UV sterilizer 28 can be used when it is disposed in the stand 24 as well as when it is disposed in the case 31. To transfer the UV sterilizer 28 from the stand 24 to the case 31, it is necessary to pull it up, the effect of the magnets will weaken, the UV sterilizer 28 can now be transferred to the case 31. To put the UV sterilizer back into the stand 24, it is necessary to pull it up again and insert same into the assembly 27 for the UV sterilizer 28 in the stand 24. The UV sterilizer is charged through the charging socket on the back of the assembly.

The claimed group of inventions provides for sanitation of the toothbrush using a UV sterilizer which is a universal UV sterilizer and can be mounted both in the toothbrush stand and in the toothbrush case.

Having thus described a preferred embodiment, it should be apparent to those skilled in the art that certain advantages of the described method and apparatus have been achieved.

It should also be appreciated that various modifications, adaptations and alternative embodiments thereof may be made within the scope and spirit of the present invention. The invention is further defined by the following claims.

What is claimed is:

1. An electric toothbrush with a toothpaste dispensing function, the electric toothbrush comprising:
a head mounted on a handle, the head including a plurality of bristles;
the handle being divided into a first compartment and a second compartment;
the first compartment including a toothpaste reservoir and a piston for pushing out the toothpaste from the toothpaste reservoir;
the second compartment including a control unit and a motor that generates vibration transmitted to the plurality of bristles,
wherein the head includes a toothpaste dispenser with a channel for dispensing the toothpaste from the toothpaste reservoir, and
wherein the toothpaste dispenser also includes first and second valves,
wherein the first valve is mounted at an entry to the channel, and the second valve is mounted next to the bristles;
the first valve is configured to dispense the toothpaste from the toothpaste reservoir into the channel;
the second valve is configured to dispense the toothpaste from an air volume in the head to the bristles;
a push-button on the head for operating the first and second valves; and
a piston in the first compartment, for pumping the toothpaste out of the toothpaste reservoir,
wherein the handle comprises a neck with an opening used for mating with the head and for filling the toothpaste reservoir with toothpaste, and
wherein the handle includes a motor button for activating the motor.

2. The toothbrush of claim 1, wherein the handle also includes a USB-C socket for charging a battery located in the handle.

3. The toothbrush of claim 1, wherein the handle also includes a light indicator of a state of the toothpaste reservoir.

4. The toothbrush of claim 1, wherein the handle also includes a magnet for mounting the electric toothbrush upright in a stand.

5. The toothbrush of claim 1, further comprising an opening in a bottom of the handle for air ingress into the toothpaste reservoir.

6. The toothbrush of claim 5, wherein the opening is configured to mate with a stand for the toothbrush.

7. The toothbrush of claim 1, wherein the first and second valves are check valves.

8. The toothbrush of claim 1, wherein the second compartment is sealed.

9. The toothbrush of claim 1, further comprising a sensor, coupled to the control unit, indicating how much toothpaste remains in the toothpaste reservoir.

10. The toothbrush of claim 1, wherein the push-button creates pressure that pushes the toothpaste through the first and second valves.

11. The toothbrush of claim 10, wherein releasing the push-button creates negative pressure that prevents the toothpaste from being sucked back into the channel.

12. The toothbrush of claim 1, further comprising a third valve that is configured to dispense the toothpaste from the channel into the air volume in the head, wherein the third valve is located at an exit of the channel.

13. The toothbrush of claim 1, wherein the piston is a free-stroke piston.
